(19) United States
(12) Patent Application Publication
(10) Pub. No.: US 2014/0368561 A1
(43) Pub. Date: Dec. 18, 2014

(54) Method For Modulating A Micro-Led Display

(71) Applicant: Jasper Display Corp., Hsinchu (TW)

(72) Inventors: Cheng-Hsing Liao, Hsinchu (TW); Chia-Jen Tsai, Hsinchu (TW); Edwin Lyle Hudson, Santa Clara, CA (US); David Charles Mcdonald, Santa Clara, CA (US); David John Cowl, Santa Clara, CA (US)

(21) Appl. No.: 14/305,295

(22) Filed: Jun. 16, 2014

Related U.S. Application Data
(60) Provisional application No. 61/835,724, filed on Jun. 17, 2013.

(51) Int. Cl. G09G 3/20; G09G 3/32

(52) U.S. Cl. CPC G09G 3/2014; G09G 3/32; G09G 2300/0857; G09G 2320/0252; G09G 2320/0271
USPC 345/692

(57) ABSTRACT

A micro-LED display device and modulation scheme for applying image data to an imager. The micro-LED display, including a plurality of micro-LED pixels disposed in rows and columns array, may use a modulation scheme. The method includes using row write actions to write data to said rows of micro-LED pixels; and using spacing of row write actions to create grey scale modulation, wherein one spacing between sequential row write actions is at a first distance while another spacing between sequential row write actions is at a second distance greater than said first distance.

### CROSS-REFERENCE TO RELATED APPLICATIONS

This application is a Continuation-in-Part of U.S. patent application Ser. No. 13/790,120, “MODULATION SCHEME FOR DRIVING DIGITAL DISPLAY SYSTEMS”, filed Mar. 8, 2013, and also claims the benefit of priority to U.S. provisional patent application Ser. No. 61/835,724 entitled “MICROLED ON SILICON”, filed Jun. 15, 2013, which is also incorporated herein by reference.

### FIELD OF THE INVENTION

The present invention pertains to digital displays, and more particularly, to modulation schemes for driving micro-LED displays.

### BACKGROUND OF THE INVENTION

Light emitting diode (LED) display technology has progressed in recent years, and has become an increasingly common option for display systems, currently making up the largest portion of the flat panel display market. This market dominance is expected to continue into the future. The superior characteristics of LED display with regard to weight, power, and geometry in image visualization, have enabled them to compete in fields historically dominated by Liquid Crystal Display (LCD) technology, such as high definition television systems, desktop computers, projection equipment, and large information boards. As the cost of LED systems continues to fall, it is predicted that they will eventually take over the market for LCD applications.

### SUMMARY OF THE PRESENT INVENTION

The present invention provides methods, systems, and apparatus for improved gray scale modulation. More specifically, the present invention uses spacing of row write actions on a display to create gray scale modulation. In one embodiment, a scheme is provided for modulating a micro-LED display by use of a system of write pointers to cause the modulation of rows to result in the generation of gray scale on the image. The present invention is based in part on the principle that a row-write function establishes a gray scale modulation state that remains in place until a new set of gray scale data is written to that same row. By controlling the writing of new data states, gray scale modulation may be achieved. Additionally, the present invention may deal with each row individually. Improved modulation efficiency may allow the use of lower frequency imaging circuits to achieve the same display image. At least some of these and other objectives described herein will be met by some embodiments of the present invention.

In one embodiment, the present invention provides a method for modulating a micro-LED display, wherein said micro-LED display comprises a plurality of micro-LED pixels disposed in rows and columns array. The method comprises using row write actions to write data to said rows of micro-LED pixels; and using spacing of row write actions to create grey scale modulation, wherein one spacing between sequential row write actions is at a first distance while another spacing between sequential row write actions is at a second distance greater than said first distance. In some embodiments, said grey scale modulation (i.e., pixel gray scale) is related to a pulse-width modulation (PWM) duty cycle (i.e., timing control). Additionally, in other embodiments, the micro-LED display comprises a silicon substrate including an integration circuit, each micro-LED pixel is disposed on the silicon substrate and emits image when being driven by two electrode currents from said integration circuit. The two electrode currents of each micro-LED pixel is toggled by using a pulse-width modulation (PWM).

In another embodiment of the present invention, a method is provided for modulating a micro-LED display, wherein said micro-LED display comprises a plurality of micro-LED pixels disposed in rows and columns array. The method comprises writing a first bit of said micro-LED pixels of a first row; writing said first bits of said micro-LED pixels of a second row; and writing said first bit of said micro-LED pixels of a third row, wherein said first row and said second row is spaced at a first distance, said second row and said third row is spaced at a second distance which is a multiple of 2 of the first distance. In some embodiments, said method for modulating a micro-LED display further comprises writing a second bit of said micro-LED pixels of the first row; and writing a third bit of said micro-LED pixels of the first row, wherein a first time interval between the writing of the first bit and the writing of the second bit is a multiple of 2 of a second time interval between the writing of the second bit and the writing of the third bit. In another embodiments, said method for modulating a micro-LED display further comprises writing a fourth bit of said micro-LED pixels of the first row on said display, wherein a third time interval between the writing of the third bit and the writing of the fourth bit is not a binary multiple of the first time interval and is not a binary multiple of the second time interval. In a still further embodiments, said method for modulating a micro-LED display further comprises writing the first bits of said micro-LED pixels of a fourth row on said display, wherein the third row and the fourth row is spaced at a third distance which is not a binary multiple of the first distance and is not a binary multiple of the second distance.

Additionally, in other embodiments, said micro-LED display comprises a silicon substrate including an integration circuit, said micro-LED pixels are disposed on the silicon substrate and emit image when being driven by two electrode currents from said integration circuit. The two electrode currents of each micro-LED pixel is toggled by using a pulse-width modulation (PWM). The integration circuit comprises a plurality of static random-access memory (SRAM) cells, each SRAM cell has two stable states, which are used to denote a zero state and an one state, and said PWM is toggled by said two stable states.

In summary, by combining micron-size light-emitting diode (uLED) arrays based on nitride semiconductors with silicon SRAM active drive circuits, the high-resolution solid-state self-emissive micro-displays capable of delivering video images is now realized.

### BRIEF DESCRIPTION OF THE DRAWINGS

FIG. 1 is a block diagram of a micro-LED on silicon display.

FIG. 2A is a circuit diagram of the integration circuit.

FIG. 2B is a circuit diagram of the integration circuit including 12 SRAM cells.

FIG. 3A shows the representation of Pulse Width Modulation.

FIG. 3B shows the representation of Multi-Pulse Width Modulation.

FIG. 4A is a diagram of the pixel arrangement of a display imager;

FIG. 4B is a graph representing the rate that a single imager write pointer progresses through an imager;

FIG. 5A is a graph representing the progression of a single imager write pointer through an imager operating under a thermometer based decoding scheme;

FIG. 5B is a graph representing the pixel voltage levels corresponding to the imager write sequence of FIG. SA;

FIG. 6A is a graph representing the progression of a single write pointer in accordance is with the present invention;

FIG. 6B is a representation of the row write sequence of the write pointer of FIG. 6A;

FIG. 7A is a graph representing the progression of two write pointers in a display in accordance with the present invention;

FIG. 7B is a representation of the row write sequence of the write pointers of FIG. 7A;

FIG. 8A is a graph representing the progression of three write pointers in a display in accordance with the present invention;

FIG. 8B is a representation of the row write sequence of the write pointers of FIG. 8A;

FIG. 9 shows a display in accordance with the present invention and the locations of a three write pointer modulation sequence on the imager window; and

FIG. 10 is a plot of the imager frequency versus least significant bit row distance for various display systems.

FIG. 11 shows a spatial representation of a row-write scheme where the motion of write pointers on a display is binary weighted and moves in a binary sequence or linear order.

FIG. 12 shows a spatial representation of a row-write scheme where the motion of write pointers on a display is binary weighted but not in a binary sequence.

FIG. 13a shows a spatial representation of a row-write scheme where the motion of write pointers on a display with a stretched least significant bit in position 1.

FIG. 13b is a chart demonstrating add bit-weight calculation for the LSB of a binary weighted modulation scheme for a display.

FIG. 14 shows a spatial representation of a row-write scheme with a mixed binary and non-binary weighted set of write pointers.

FIG. 15 shows a spatial representation of a row-write scheme with binary weighted write pointers having uniform weighted higher order bits.

FIG. 16 shows a spatial representation of a row-write scheme with binary weighted write pointers having uniform weighted higher and lower order bits.

FIG. 17 shows a spatial representation of the motion of write pointers on a display with 3 bit-plane weightings.

FIG. 18 shows a near-eye application of a display according to the present invention.

### DETAILED DESCRIPTION OF THE INVENTION

It is to be understood that both the foregoing general description and the following detailed description are exemplary and explanatory only and are not restrictive of the invention, as claimed. It should be noted that, as used in the specification and the appended claims, the singular forms “a”, “an” and “the” include plural referents unless the context clearly dictates otherwise. Thus, for example, reference to “a material” may include mixtures of materials; reference to “a display” may include multiple displays, and the like. References cited herein are hereby incorporated by reference in their entirety, except to the extent that they conflict with teachings explicitly set forth in this specification.

In the following description we will make use of the term “write pointer”. A write pointer points to a row on the display which has a particular row spacing relationship to the rows below and above it which are also pointed to by write pointers. The locations of a set of write pointers are not fixed but rather move in a linear fashion according to a predetermined scheme. This movement of write pointers is essential to the creation of gray scale in images after the present invention. This first class of write pointers may be called virtual write pointers, but may be referred to without specific use of the term “virtual.” The distinction is clear to those skilled in the art. A second class of write pointers is referred to as physical write pointers. In one embodiment, the physical write pointer may service the virtual write pointers in turn. The terms “row” and “row write actions” as used herein are not limited to horizontal orientations and may be used to included lines at a variety of orientations, including vertical and those other than horizontal.

By combining micron-size light-emitting diode (uLED) arrays based on nitride semiconductors with silicon SRAM active drive circuits, the high-resolution solid-state self-emissive micro-displays capable of delivering video images is now realized.

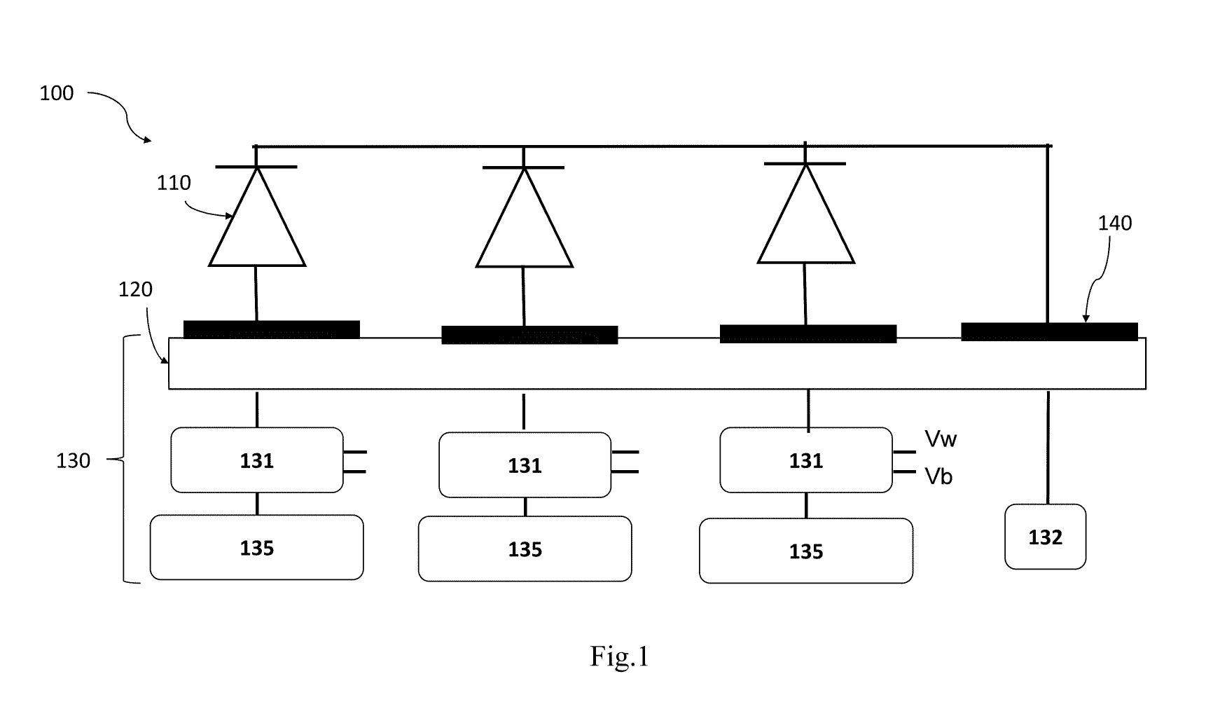

FIG. 1 show one embodiment of a micro-LED display 100. The micro-LED display 100 comprises a plurality of micro-LED pixels 110 disposed in rows and columns array and a silicon substrate 120 including an integration circuit 130. Each micro-LED pixel 110 in between a pixel electrode 131 and a common electrode 132 is disposed on the silicon substrate 120. The silicon substrate 120 includes nitride semiconductors. The silicon substrate 120 and the micro-LED pixels 110 are bonded by a plurality of conductive pads 140. The conductive pads 140, such as a bowl-shaped bump, is formed to define a bowl-shaped reflecting surface. The micro-LED pixels 110 are mounted on the bowl-shaped reflecting surface, which is as a pixel mirror.

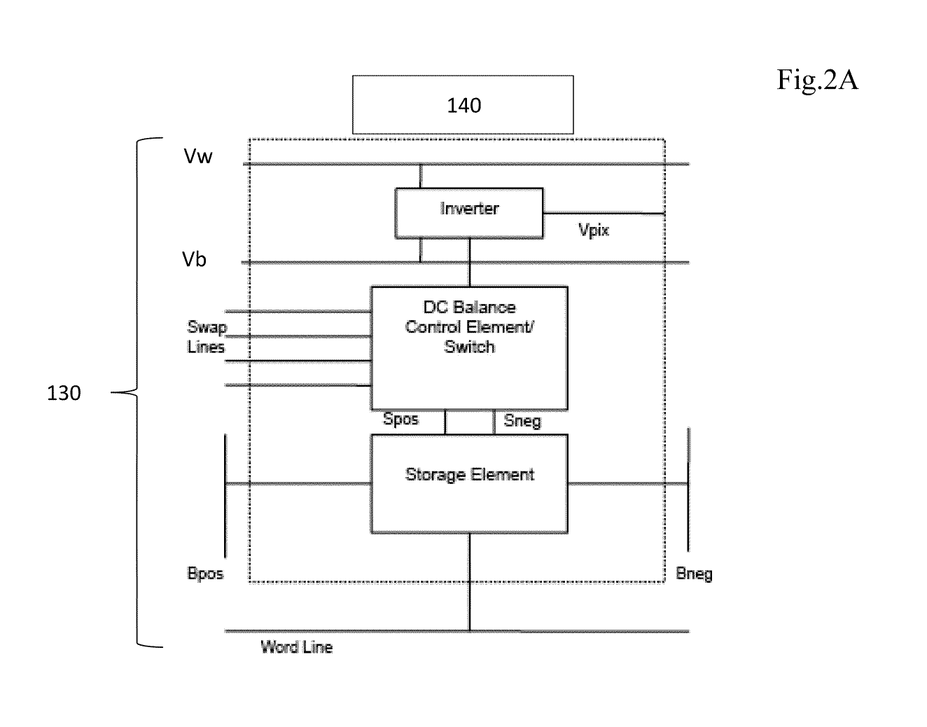

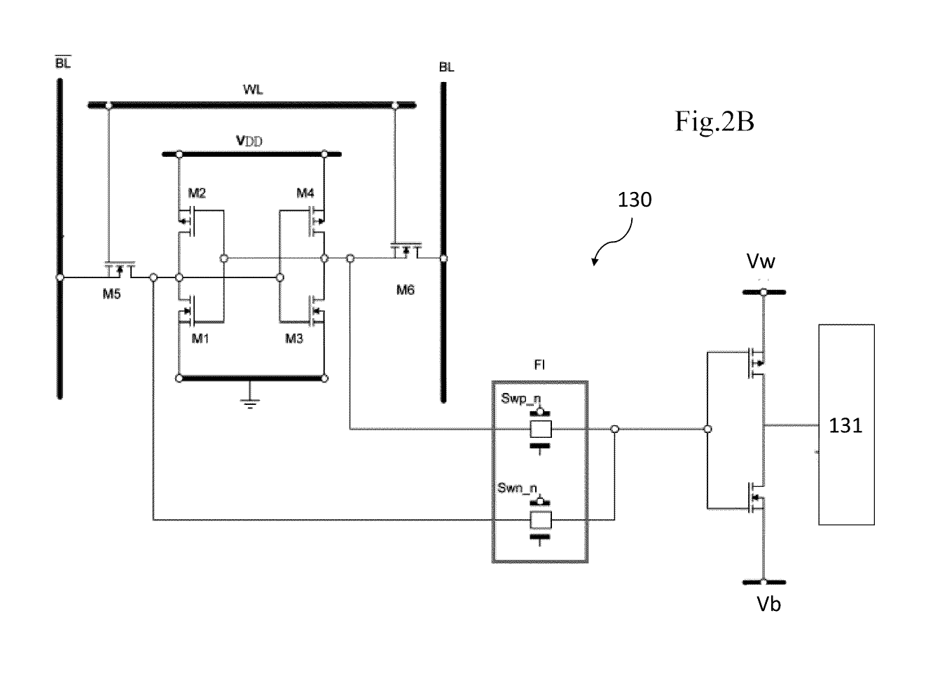

The micro-LED pixels 110 emit image when being driven by two electrode currents from said integration circuit 130. Refer to FIGS. 1, 2A and 2B, the integration circuit 130 includes a storage element 135, for example, a plurality of static random-access memory (SRAM) cells. In this embodiment, the integration circuit 130 includes 12 SRAM cells. The storage element 135 is coupled to the pixel electrode 131. Each SRAM cell 135 has two stable states, which are used to denote a zero state and an one state, without leakage. The two electrode currents of each micro-LED pixel 110 is toggled by using a pulse-width modulation (PWM). The PWM is toggled between two electrodes current, which is relative to two pixel voltages (Vw or Vb), and two pixel voltages can covert to current of the micro-LED pixels 110 are toggled by said two stable states of the SRAM cell 135. In the embodiment, the pixel voltages, Vw and Vb, are fed by same source, easy to maintain precision, less image retention, good per pixel uniformity. If one pixel voltage is used the entire drive time, the behavior is similar to the analog drive.

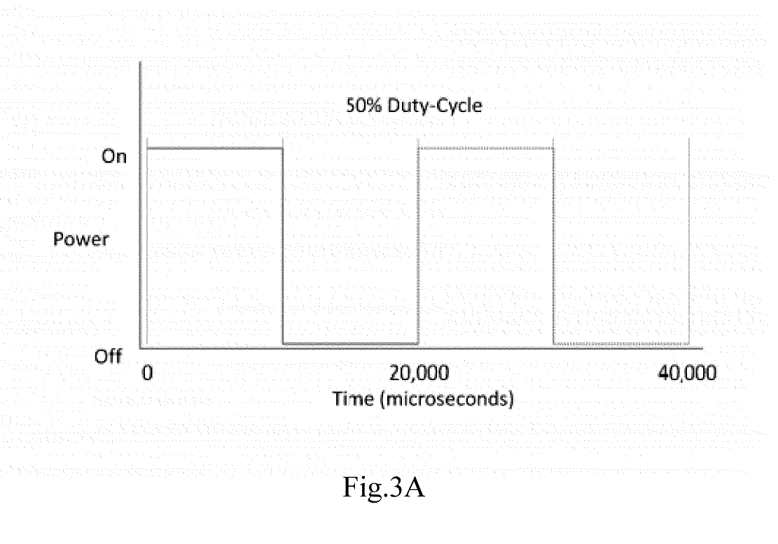

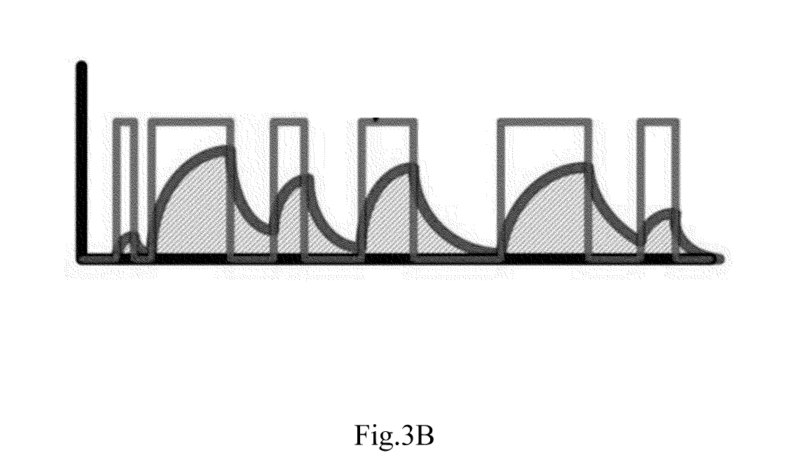

FIG. 3A shows the representation of Pulse Width Modulation. In the embodiment, the micro-LED display is driving by Pulse Width Modulation (PWM). The grey scale modulation (Pixel gray scale) is related to a PWM duty cycle (timing control). The brightness of the micro-LED pixels is controlled by varying the power which is sent to the micro-LED pixels. For example, using a potentiometer (variable resistor), the more power the micro-LED pixel receives the brighter it is, the less power it receives the dimmer it is. However, the microcontrollers are digital, meaning the microcontrollers only have two ‘power’ states, on and off. A varying power can be supplied from a microcontroller (using a Digital to Analogue Convertor (DAC)); however, an additional chip is required. PWM provides the ability to ‘simulate’ varying levels of power by oscillating the output from the microcontroller. If, over a short duration of time, the micro-LED pixel is turned on for 50% and off for 50%, the micro-LED pixel will appear half as bright since the total light output over the time duration is only half as much as 100% on. The important factor here is the ‘duration’. If the light on and off is turned too slowly, the viewer will see the flashing of the micro-LED display not a constant image output which appears dimmer. The pulsing width (in this case 50%) is the important factor here. By varying (or ‘modulating’) the pulsing width, the image output from the micro-LED display is effectively controlled, hence the term PWM or Pulse Width Modulation.

FIG. 3B shows the representation of Multi-Pulse Width Modulation. In the same embodiment, the multi-PWM is more flexibility and have benefit for image adjust or tuning to meet different retirement of image quality and color management, likes white balance, flicker, uniformity compensation and gamma correction, even for the temp correction with different display material by the method of the present invention. Moreover, the fringe field effect and flicker reduction is solved by the method of the present invention. The unique method is described in U.S. patent application Ser. No. 13/340,100, which is hereby incorporated by reference in its entirety herein for its teachings on “Gray scale drive sequences for pulse width modulated displays”. Also, the unique method is described in U.S. patent application Ser. No. 10/435,427, which is hereby incorporated by reference in its entirety herein for its teachings on “Modulation scheme for driving digital display systems”.

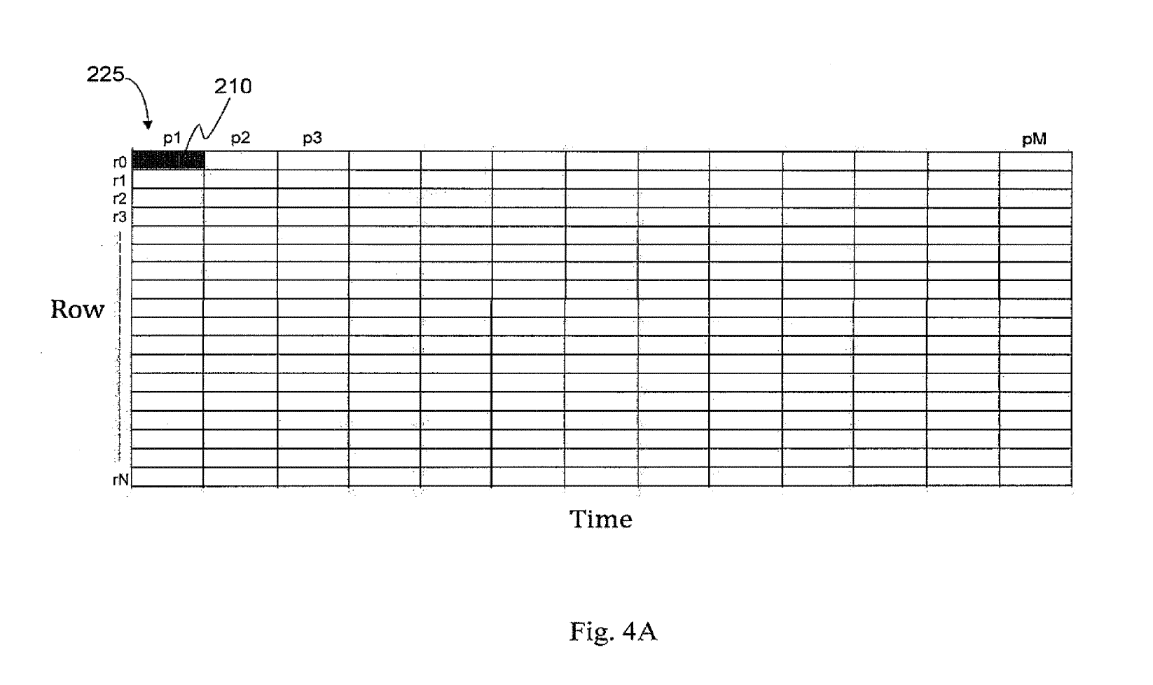

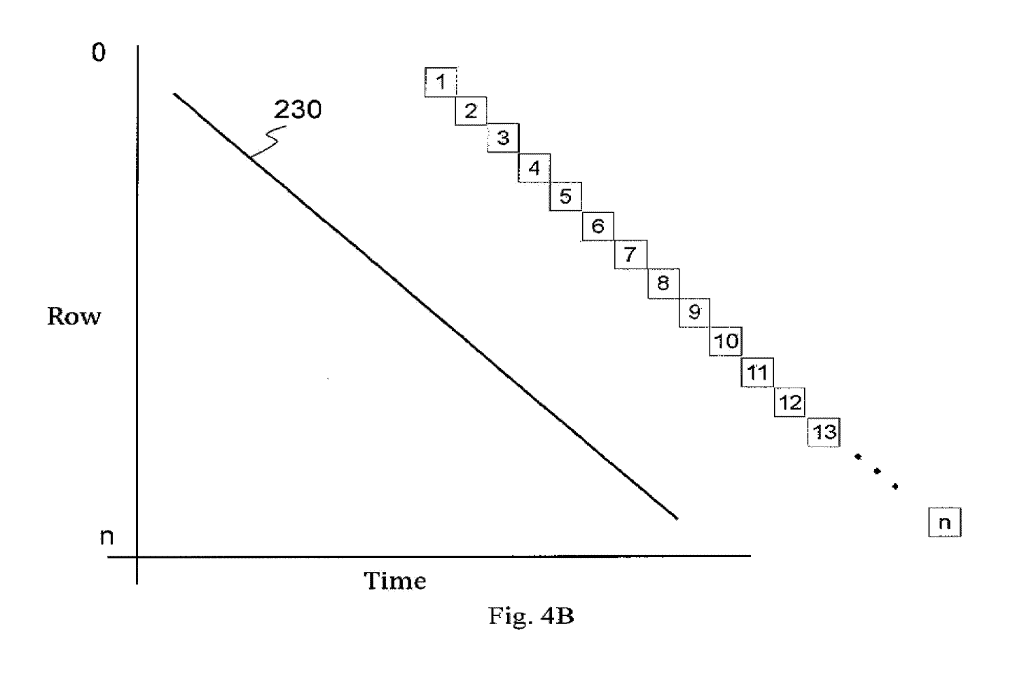

FIGS. 4A and 4B schematically represent an imager 225 (FIG. 4A) and a known pixel row writing scheme (FIG. 4B). The imager 225 is composed of an array of pixels 210, the number of such pixels being determined by multiplying the number of rows N by the number of pixels per row (M). In the example of FIG. 4A, the imager is divided into N rows, where each row has M pixels. Each pixel 210 is essentially identical and represents a discrete point of image data. FIG. 4B depicts the row versus time writing scheme of the imager represented in FIG. 4A. FIG. 4B illustrates how a known imager write scheme is implemented. In FIG. 4B each numbered box (1 through n) represents one pixel row in the imager.

Following the row write sequence in FIG. 4B, one row is written at a time, with the write sequence progressing sequentially through all of the rows of the imager beginning at the top (ri) of the imager and ending at the bottom (rN) of the imager. As the writing sequence of each row N is initiated, each of the pixels 210 in each row are written sequentially, one at a time, from left to right, beginning with pixel p1, and progressing through pixel pM. The time it takes each row to complete writing is the time it takes the system to sequentially write each of the pixels p1-pM in that particular row. The slope of line 230 represents the rate at which the rows in the imager 225 are written. A steeper slope indicates that a single row of the imager is “refreshed” or rewritten, more often. As such, a steeper slope of line 230 means that the display produced by the imager is written once through at a faster rate. FIG. 4B depicts a modulation scheme that utilizes a single write pointer to write image data to the imager. Utilizing this scheme, a single pixel on the imager can only be rewritten (i.e. the data value is updated) when the single write pointer again reaches that point in the display. Once the write pointer has progressed through the entire display, the write pointer resumes at the top of the display.

As an example, if an imager system takes 0.41 microseconds (μsec) to write each row in an imager that has 1000 rows, it will take:

1000 rows*0.41 μsec/row=410 μsec

to write every row of the imager once. Therefore, any individual element (pixel) on the imager can have its value changed no more often than once every 410 μsec. The rate at which each row in the display is written is a variable depending on the speed of the underlying system and the limitations of the circuitry that drives the display (e.g., the number of pixels that can be written each clock cycle).

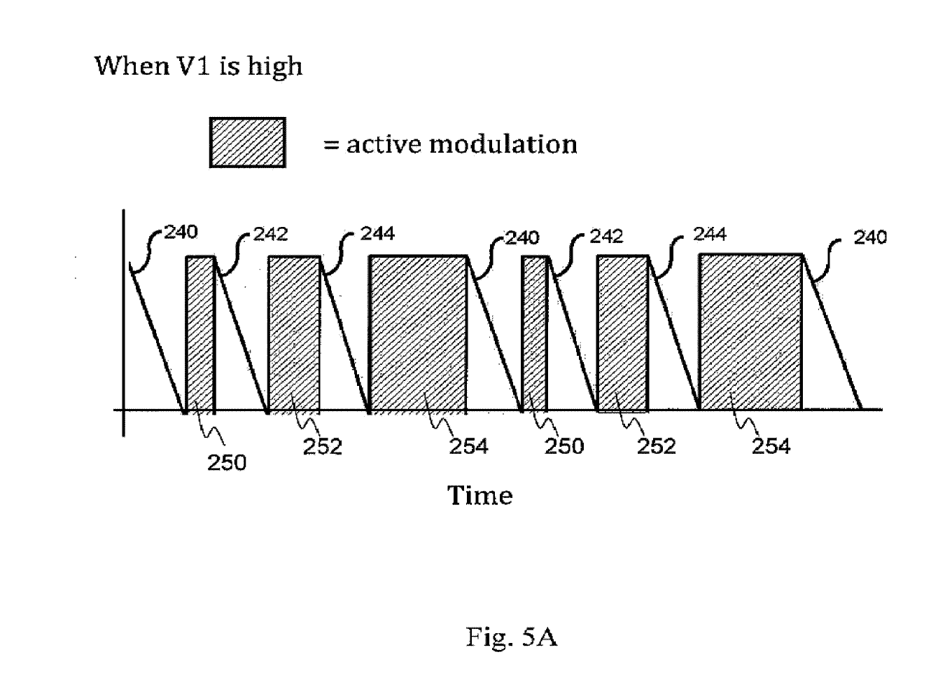

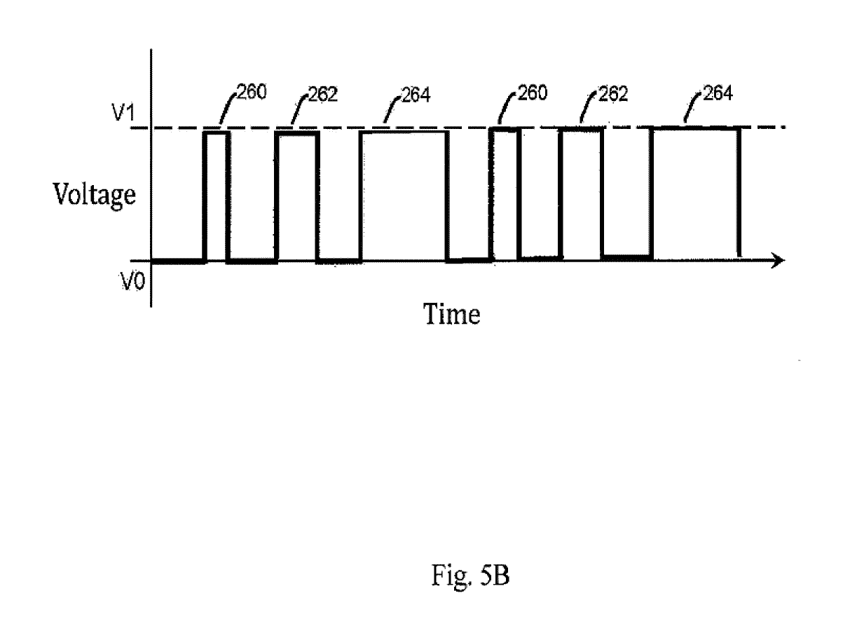

FIGS. 5A and 5B schematically represent another known row/pixel writing scheme where increased thermometer decoding is used. Briefly, thermometer decoding consists of a series of equally weighted time values followed by a series of binary weighted time values. In the example of FIG. 4B, an increased number of non-overlapping sequential imager write pointers are utilized. In other words, only a single write pointer is “active” on the display at any given time. FIG. 5A shows the rate of row write pointers 240, 242, and 244, and the related time frames 250, 252, and 254 where active modulation occurs. FIG. 5B correlates the pixel voltage associated with each of the time sequences of FIG. 5A. Notably, modulation can only occur when the drive voltage is at a high state (i.e. vi), and does not occur during the write sequence of the pixel rows—where the write pointers 240, 242, and 244 are “active” on the display.

The modulation scheme shown in FIGS. 5A and 5B presents a time conflict between the imager write pointer load time and the active modulation time. Since the two events cannot happen during a common time interval, this limits the efficiency of this type of digital modulation scheme.

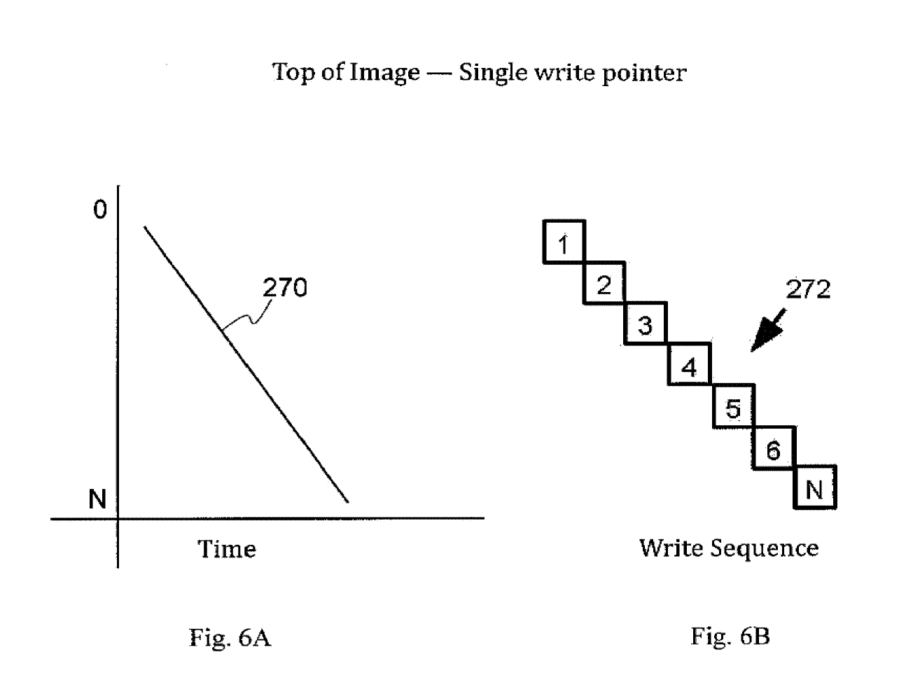

Referring to FIGS. 6A and 6B, a single write pointer 270 (FIG. 6A) and the corresponding row write sequence 272 (FIG. 6B) are shown. The write sequence of FIGS. 6A and 6B shows sequential row writes with a sequence as follows:

Cycle 1—write row 1

Cycle 2—write row 2

Cycle 3—write row 3

Cycle n—write row N

This sequence continues through each of the rows in the imager. Since this scheme utilizes only a single write pointer, it advances through the display with a speed of:

Single Row Write Time=# pixels in one row (pixels/row)/32(pixels/cycle)/imager frequency(cycles/sec)

where “# of pixels in one row” represents the horizontal pixel resolution of the imager, namely the number of pixels in a single row on the imager. The numerical value “32” represents the number of pixels that can be written to the imager in a single 32 bit clock cycle. “Imager frequency” represents the speed of the imager clock that is driving the system. For example, in an imager that has 1408 pixels per row, it would take 44 clock cycles to write data to the entire row. If the imager clock frequency were 100 MHz (100,000,000 cycles/sec or 1*10⁻⁸ sec/cycle), it would take 44*10⁻⁸ seconds to write one row. If the imager had 1050 rows, it would take 462*10⁻⁶ seconds to write every pixel in the imager once through. Again, the above example assumes only a single write pointer.

FIGS. 6A and 6B are shown to illustrate the relation of a known bit-write scheme to one in accordance with the present invention. The write plane of the imager of FIGS. 6A and 6B, the distance and time between successive write pointers updating the same point on the display, is essentially the time it takes for the single write pointer to update the entire display.

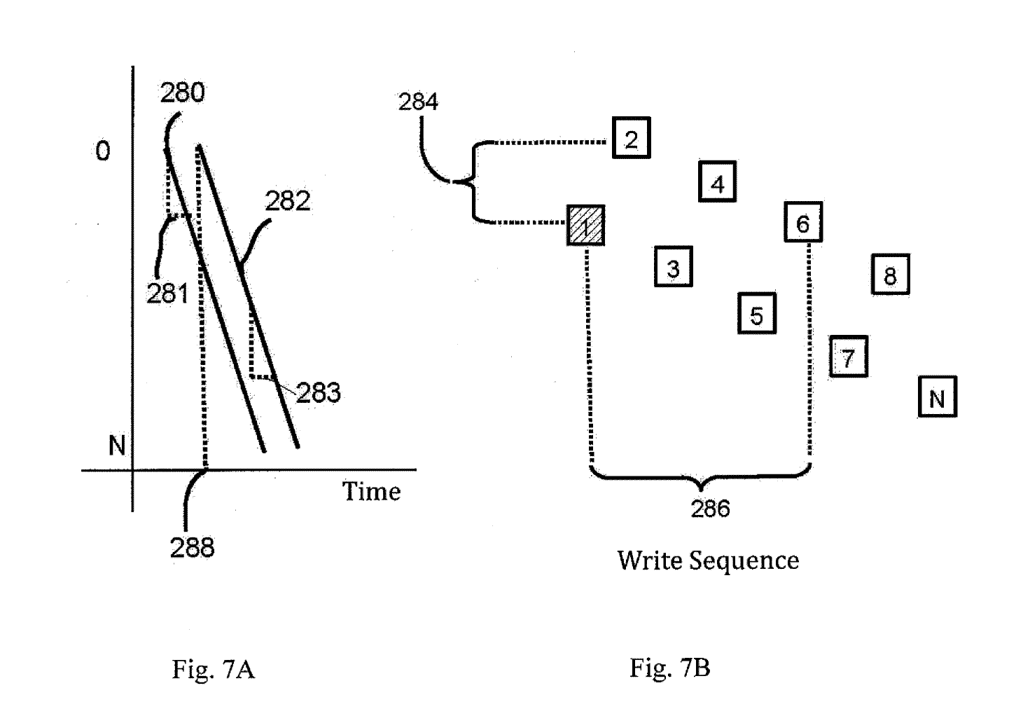

FIGS. 7A and 7B show a modulation scheme in accordance with the present invention that provides multiple write pointers that are active within the same imager. In one embodiment, the write pointers may be simultaneously active on the same imager. In another embodiment, more than one write pointer may be active on the screen at any given moment but are serviced in turn by the physical row-write scheduler. The use of multiple write pointers allows modulation to occur at several places on the imager without requiring a single write pointer to progress through the entire display. Data can also be refreshed while the write pointers are active. A scheme may be used whereby multiple write pointers are defined for a display device. Each write pointer corresponds to a bit plane of image data. A given set of bit planes has a relationship to a set of source image data. In other words, for this embodiment, each bit plane has a relationship to a gray scale level, and a given set of bit planes will create a particular gray level that corresponds to an image source data set.

The time and distance representations between the different write pointers are referred to as write planes. The write plane in the two write pointer embodiment are closer together in distance than the one write pointer embodiment. If each of the write pointers are 15 addressable with low overhead, a second, third, or more write pointers can be created. The optimal number of write pointers is described in more detail below.

In FIGS. 7A and 7B, two overlapping write pointers are utilized rather than a single one. A first write pointer 280 progresses through the display with a velocity defined by a rate slope 281 and a second write pointer 282 progresses through the display with a velocity defined by a rate slope 283. In FIG. 7A, the two write pointers 280 and 282 are overlapping in time. For example, when the write time reaches a point 288, both of the write pointers 280 and 282 are simultaneously active on the imager. FIG. 7B shows the row-write sequence for the two write pointers 280 and 282. Each of the numbered boxes (1 through N) represents one pixel row in the imager and all pixels in that row. As seen from the row write sequence of FIG. 7B, the row-writes do not proceed sequentially through the imager rows from top to bottom. The speed that each write pointer progresses through the imager is different from a scheme that utilizes only one write pointer. With two write pointers, each write pointer (and thus teach write plane) advances through the display with a speed of:

Two Write Pointer Write Time=# pixels in two rows (pixels/row)/32(pixels/cycle)/imager frequency (cycles/sec)

or:

Velocity_{(2 write pointers)}=Velocity_{(1 write pointer)}/2

Since the two write pointers are alternating writing their respective rows, twice as many pixels have to be written in order to complete writing a row in the display. For this embodiment, the above equation shows the relationship between the speed the write pointers move and the number of write pointers. Velocities may be in terms of rows per unit time. The velocity of course for the pointer depends on the clock because the clock determines how many pixels per clock can be written, which determines how long it takes to write a row.

In the present embodiment, if there a number of virtual write pointers, each one of those write pointers may be serviced in sequence. The sequence is the spacing between write pointers is not completely uniform. The spacing between lower order write pointers is binary weighted or may be binary weighted. And the spacing between upper write pointers may be rather than being binary weighted, may be uniformly weighted as will be discussed herein.

With two write pointers progressing through the display at the same time, a write plane is defined as the distance and time between the two write pointers. Each write pointer, and thus the intermediate write plane, in the embodiment of FIG. 7A advances at half of the velocity of the write pointer in the one write pointer embodiment.

In FIG. 7B, reference number 284 shows the value of the row-least significant bit (rLSB). The rLSB value 284 represents the number of rows contained in the least significant write plane and the least amount of time that a particular row will remain at a given value before its value is changed by a next write pointer passing that row. Reference number 286 shows the value of the time-least significant bit (tLSB). The tLSB value is the time value associated with two vertically adjacent rows' values being written with data. In the embodiment of FIGS. 7A and 7B, each write pointer is initiated with a load address to the alternate write pointer so that a sequence of row writing alternates between each of the write pointers that are active in the display.

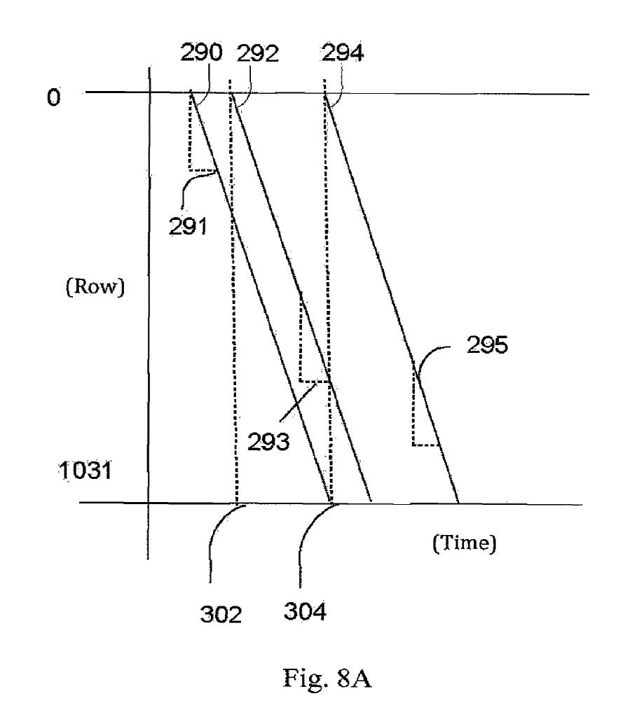

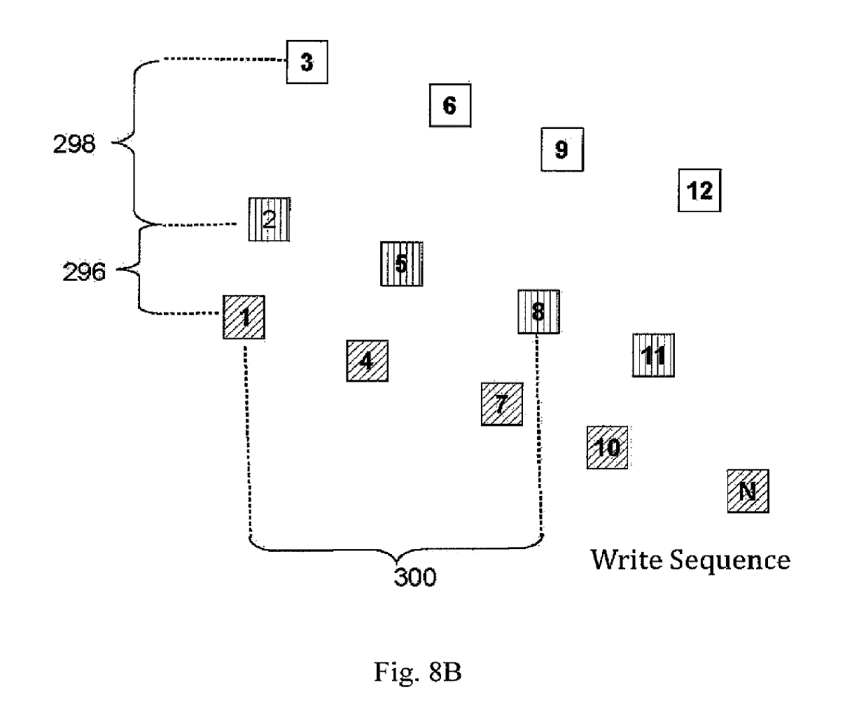

FIGS. 8A and 8B show a modulation scheme in accordance with the present invention that utilizes three overlapping write pointers 290, 292, and 294. FIG. 8A illustrates that the time (and thus distance) spacing of the three write pointers 290, 292, and 294 are not equal. Rather, the time-distance spacing of the write pointers follows a binary weighted scheme, where the distance between the second write pointer 292 and the third write pointer 294 is twice the distance between the first write pointer 290 and the second write pointer 292.

The first write pointer 290 progresses through the display with a velocity defined by a rate slope 291, the second write pointer 292 progresses through the display with a velocity defined by a rate slope 293, and the third write pointer 294 progresses through the display with a velocity defined by a rate slope 295. In FIG. 8A, the three write pointers 290, 292, and 294 are overlapping in time consistent with the binary weighted scheme described above. For example, when the write time reaches a point 302, each of the write pointers 290 and 292 are simultaneously active on the same imager. Similarly, when the write time reaches a point 304 each of the write pointers 292 and 294 are simultaneously active on the same imager.

FIG. 8B shows the row-write sequence for the three write pointers 290, 292, and 294. Each of the numbered boxes (1 through N) represents the writing of one row in the imager and all pixels in that row. As seen from the row write sequence of FIG. 8B, the row-writes do not proceed sequentially through the rows from top to bottom. The speed that each write pointer progresses through the imager is different than the one or two write pointer embodiments. With three write pointers, each write pointer (and thus each write plane) advances through the display with a speed of:

Three Write Pointer Write Time=# pixels in three rows (pixels/row)/32(pixels/cycle)/imager frequency (cycles/sec)

or

Velocity_{(3 write pointers)}=Velocity_{(1 write pointer)}/3

Since the three write pointers are alternating writing their respective rows, three times as many pixels have to be written in order to complete writing a row in the display.

With three write pointers progressing through the display at the same time, there are three write planes defined, however, the display width of each of the write planes is not the same since the distance between each of the write pointers is defined by a binary weighted value. Each write pointer (and thus the intermediate write planes) in the embodiment of FIG. 8A advances at one third of the velocity of the one write plane embodiment of FIG. 6A.

In FIG. 8B, reference number 296 shows the value of the row-least significant bit (rLSB). The rLSB represents the number of rows contained in the least significant write plane and the least amount of time that a particular row will remain at a given value before its value is changed by a next write pointer that is passing that row. Reference number 298 represents two rLSB's, or the second value in the binary weighted scheme. Reference number 300 shows the value of the time-least significant bit (tLSB). The tLSB is the time value associated with two vertically adjacent rows values being written with data. In the embodiment of FIGS. 8A and 8B, each write pointer is initiated with a load address to an alternate write pointer so that a sequence of row writing alternates between each of the write pointers that are active in the display.

The above embodiments can be extended to have a larger number of write pointers 20 activated simultaneously. In accordance with the present invention, this technique has been extended in demonstration to up to 24 write pointers being simultaneously displayed. No specific limit on the number of write pointers exists. Rather the limit is established for a particular display resolution by the required bandwidth of the system and by the available memory within a particular instance of the controller system after this invention. The binary weighted distance between the various write pointers results in write planes that progress through the imager and update the data value of a given pixel row at a rate that is greater than that of a single write pointer, even though the velocity through the display of each write pointer in a multi-write pointer embodiment is slower than that of the single write pointer embodiment.

This technique effectively turns time into a distance by virtualizing the write pointers, in order to create a large number of write pointers. Each of the virtual write pointers moves forward with the same velocity (relative to the other write pointers simultaneously displayed). This velocity is a fraction of the maximum velocity that a single write pointer can advance. Therefore, setting the distance between each of the virtual write pointers sets the amount of time that any pixel stores its last written data.

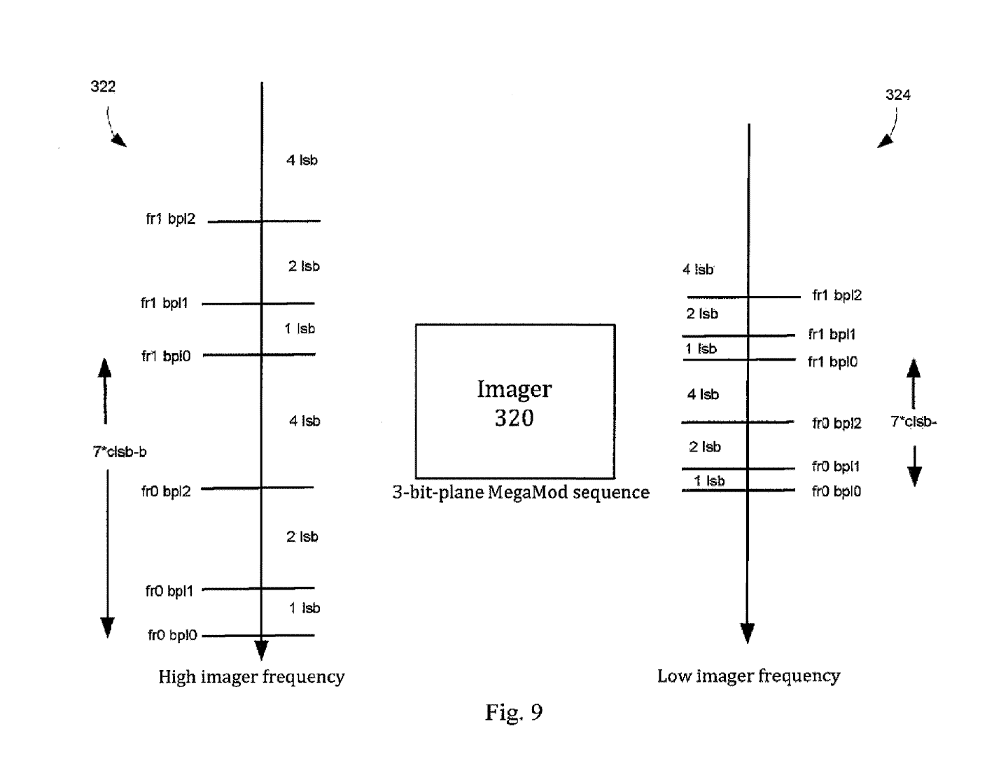

It is noted that the maximum number of virtual write pointers simultaneously displayed on the imager is not necessarily the same as the number of total write pointers available to the system. This results in several different possible write pointer velocity/imager frequency combinations. For instance, if the clock rate and therefore the rate of each write plane is increased, and since the time for any single element to display a particular value for time (t) is the distance between the two adjacent write pointers, there are rates (R) where the distance between the two pointers may be greater than the number of elements or rows on the entire imager. As the imager input frequency increases, the programmed distance (in whole rows) may increase correspondingly in order to maintain the same LSB time. As this “row distance” between pointers increases, a point is reached where another currently displayed write pointer “falls off” of the screen and is not active on the imager. FIG. 9 illustrates this feature. Imager 320 represents the physical size of an imager including its relation to the sequence of write pointers advancing across it. Write pointer sequence 322 shows the write pointer spacing with a high imager frequency and write pointer sequence 324 shows the write pointer spacing with a low imager frequency. Both sequence 322 and sequence 324 utilize a three write pointer modulation scheme. In the sequence 322, there are points in time where only one write pointer is active on the imager, and there are points in time where three write pointers are active on the imager. Similarly, in the sequence 324, there are points in time where four write pointers are active on the imager and there are points in time where there are six write pointers active on the imager. For a given LSB row distance, as the number of (peak) write pointers on the screen increases, the write speed may also increase in order to keep the forward velocity pointers (and thus the write planes) the same. This effect coupled with the number of write pointers on the screen at one time (which is a function of the write speed and therefore the frequency), leads to a nonlinear set of optimum frequencies for a given imager size, frame rate, and number of write pointers. As the number of pointers that are simultaneously active on the imager drops, the effective velocity of the pointer increases, resulting in several answers of frequency-velocity-number of pointer values in order to produce the same image.

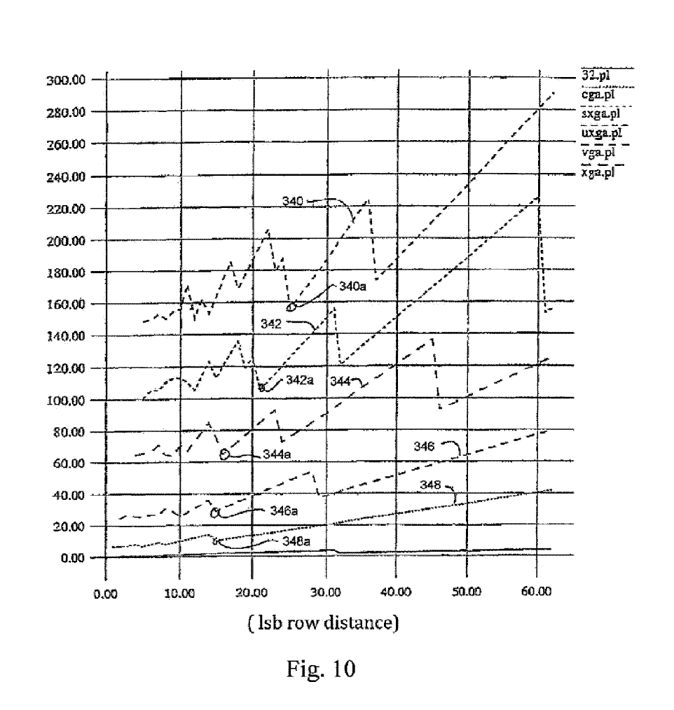

FIG. 10 plots the LSB row distance against the imager clock frequencies for various imager sizes, including XGA, VGA, UXGA, SXGA, and CGA display resolution. Also included in the plot of FIG. 10 is a test imager size “32” which represents an imager with only 32 rows. Apparent from FIG. 10 is that there are a large number of combinations of imager frequencies and LSB row distances (i.e., anywhere along each of the respective line plots). It is preferable, however, to utilize lower frequency imagers since imaging hardware that runs at a lower frequency typically costs less to manufacture and requires less power. For instance, the low points for each of the plots in FIG. 10 would be optimum combinations for the system. (See e.g., points 340a, 342a, 344a, 346a, and 348a). While any point along the plot would be a workable combination, the lower frequency points lend the best application to systems manufactured in accordance with the present invention.

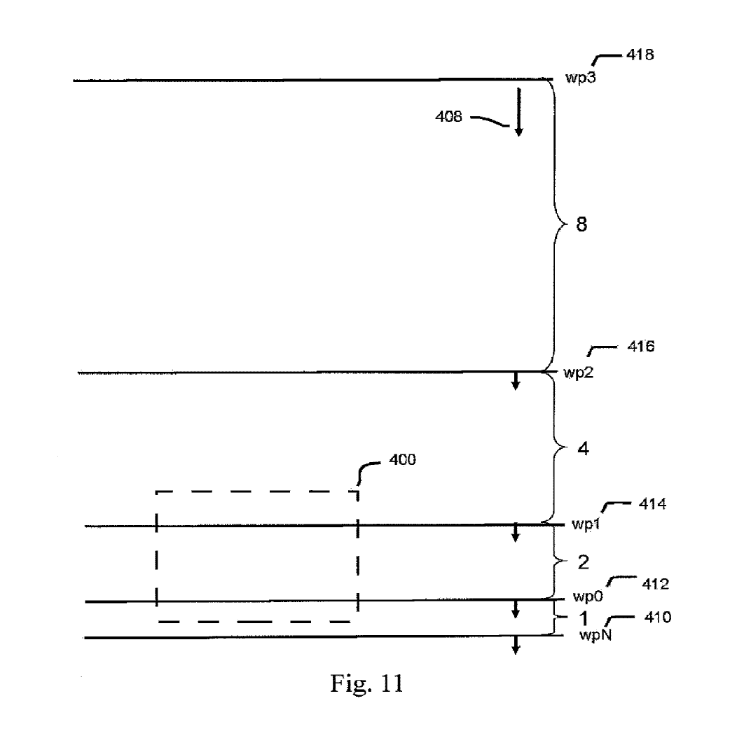

Referring to the embodiment of FIG. 11, the motion and temporal spacing of a set of virtual binary-weighted write pointers relative to the face of a display device is depicted. Such a sequence of the motion of write pointers on display may be used with any of the methods and devices describe above. The virtual write pointers present on the face of the display 400 are serviced by a physical write pointer. It should understood, of course, that this row-write scheme may also be used with a system having a plurality of physical write pointers. The row-spacing of the motion of the write pointers is proportional to the binary weightings of the gray-scale values associated with that write pointer. The choice of row-write and row velocity is described above. In this instance, wpn 410 is the last write pointer of the previous modulation sequence. The spacing between wpn 410 and wp0 412 establishes the size of one “least significant bit” or LSB. In this embodiment, the spacing between wp0 412 and wp1 414 is double the number of rows between wpn 410 and wp0 412, thus creating a value of two LSBs. In like manner the spacing between write pointers wp1 414 and wp2 416 is double that of the spacing between write pointers wp0 412 and wp1 414, or four LSBs. In the final examples, the spacing between wp3 418 and wp2 416 is eight LSBs. With this combination of write pointers, it is possible to represent gray scale values from 0 to 15. Note that in this non-limiting example, the binary weight values are in ascending and monotonic order, since those depicted above represent later modulations and each write pointer interval is larger than all those below it. The sequence of the weightings is 2⁰, 2¹, 2², 2³, and can be extended to a number of additional weightings.

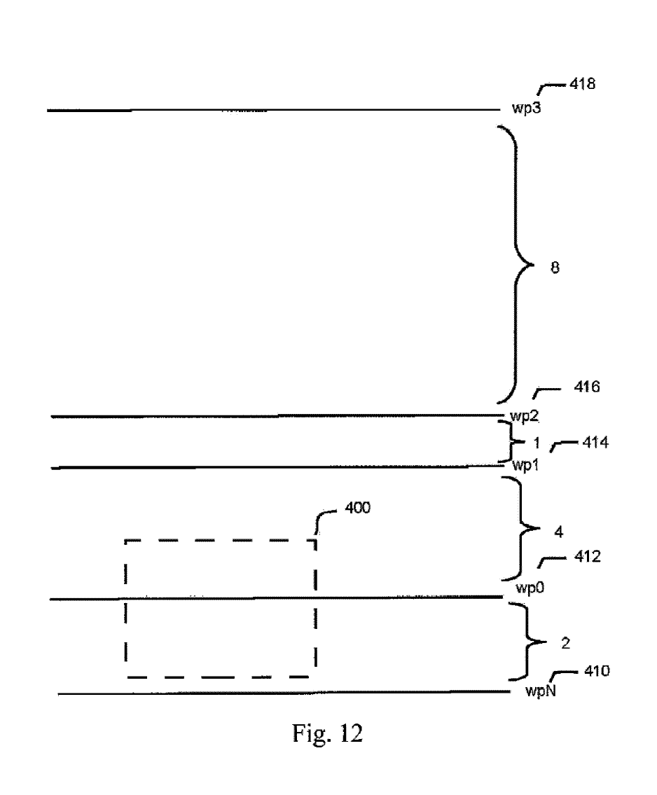

FIG. 12 presents another embodiment of a binary-weighted data sequence. In this figure, the write pointer spacing and sequence weightings corresponds to 2¹, 2², 2⁰, 2³. This sequence is equivalent to the sequence disclosed in FIG. 11 in terms of the number of gray scale levels support, but the difference in order may occasionally be important. The inventors have experimentally noted that placing the least significant bit 2⁰ between rows wp1 414 and wp2 416 immediately adjacent to a much higher order bit wp2 416 and wp3 418 can alleviate some difficulties in gray scale that may be related to the response time. This configuration can be advantageous for handling LSB's. LSB's can be issue because the step response on the micro-LED display may be much slower than the bit time. The previously described method may be used to add a small correction factor corresponding to an adjustment in the row spacing by one or more additional rows or such number of row or rows as desired to mitigate the error.

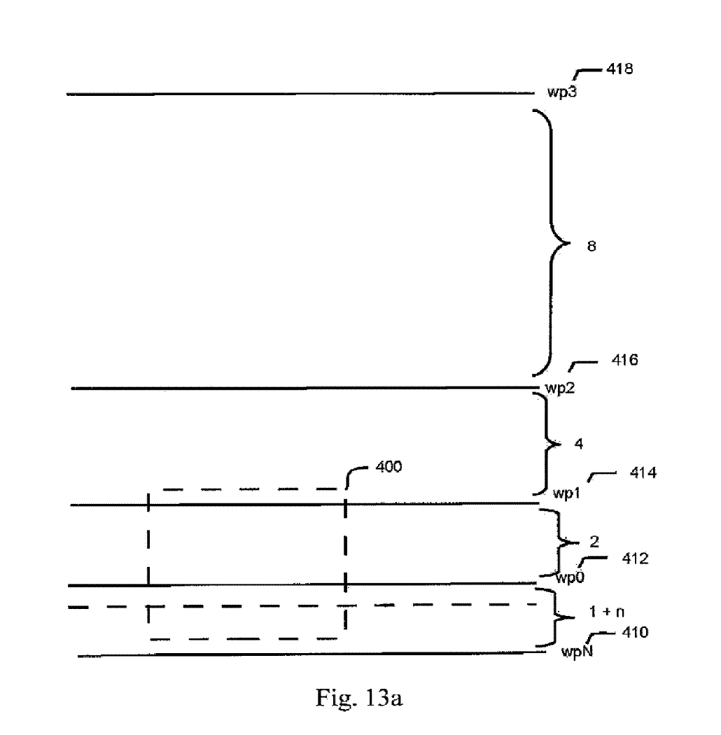

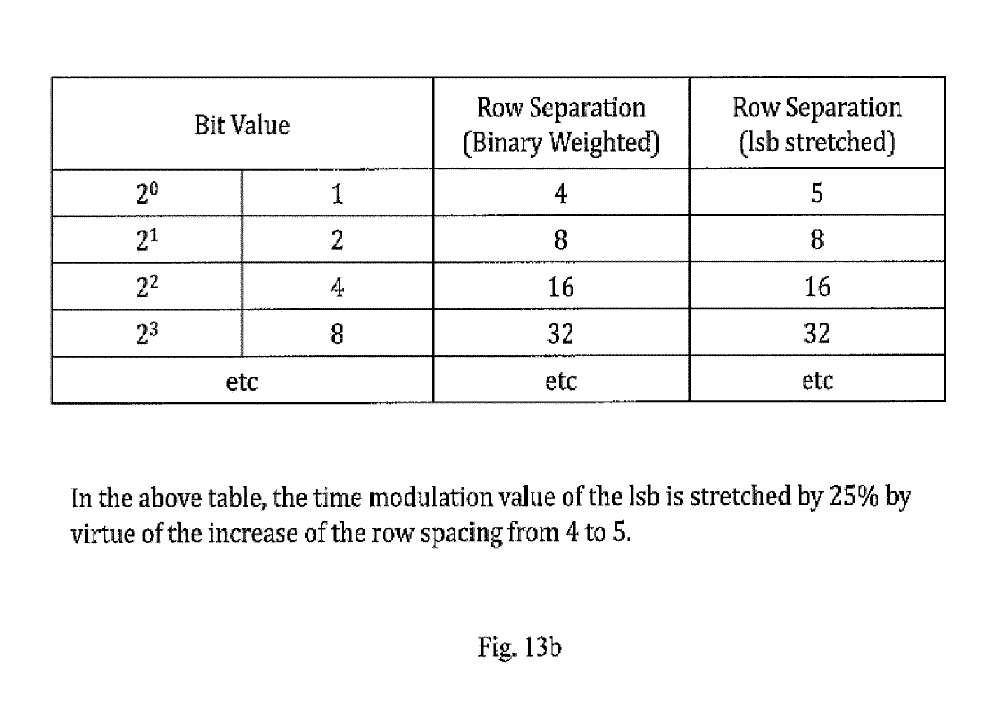

FIG. 13a presents a still further embodiment of the binary weighted data sequence disclosed if FIG. 11, wherein the value of the first LSB 2⁰ is increased by the number n where n is a rational number, a fraction, whose denominator is the unmodified number of rows between wpn 410 and wp0 412 and whose numerator is a small integer number, perhaps one or two, used to increase the weighting of the LSB. This has the effect of stretching the LSB by a fraction of the binary LSB weighting. This calculation is presented in FIG. 13b. One purpose of the weighting is to improve the linearity of the gray scale response without being bound to a particular data sequence. In the non-limiting example presented in FIG. 13a the data sequence is 2⁰n, 2¹, 2¹, 2², 2³.

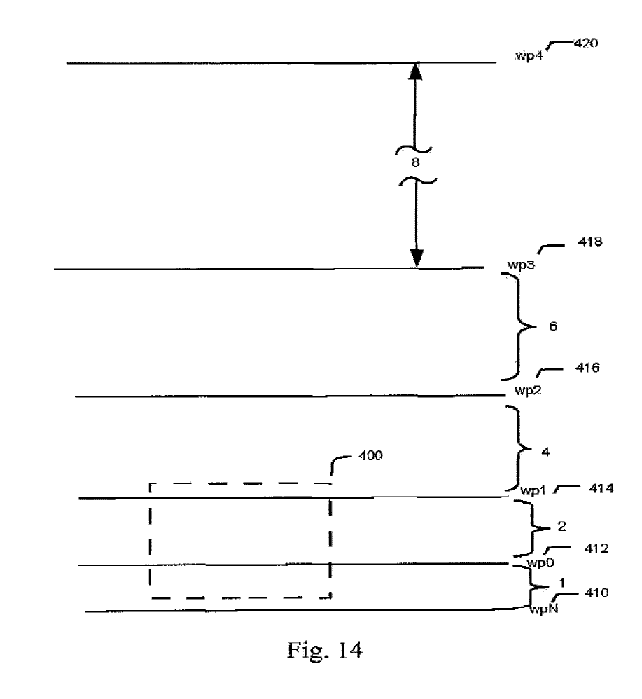

FIG. 14 presents another embodiment of a write pointer sequence wherein additional non-binary weightings are given to some added bit planes. In this embodiment, there is more than one sequence of bit planes that can create a given modulation gray scale weight. The present invention provides a version of the modulation sequences postulated therein, but implemented in a new fashion. The advantage of this embodiment of the invention is that it permits the breakup of data phasing.

In the embodiment of FIG. 14, the interval sequence for gray scale modulation is now 2⁰, 2¹, 2², 2²+2, 2³, or 1, 2, 4, 6, 8 (wp3 418 to wp4 420). The total number of levels of gray scale that can be shown is now 22—levels 0 to 21. Additionally, many intermediate gray levels can now be shown as a combination of several different bit planes. For example, the gray level eight can be generate by the bit plane weighted 8 or by the bit planes weighted 6 and 2. This adds a great level of flexibility that can be applied to the mitigation of optical artifacts.

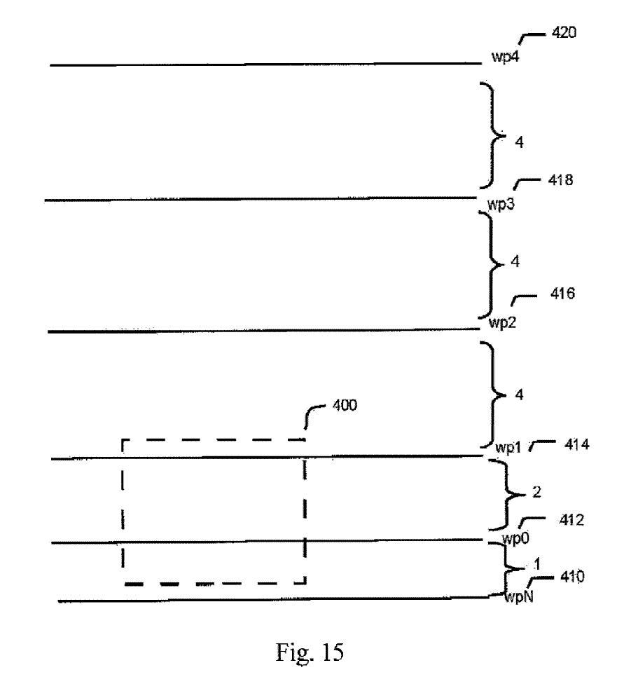

FIG. 15 shows another embodiment of a write pointer scheme where lower bits are binary weighted bit planes and where higher bit plane weights are all of an equal binary value. In this embodiment, the bit plane sequence is 2⁰, 2¹, 2², 2², 2². All bit weights from 0 to 15 can be display with equal temporal efficiency. With appropriate preprocessing all higher order bit plans can be kept in phase to reduce such optical defects as dynamic false contouring.

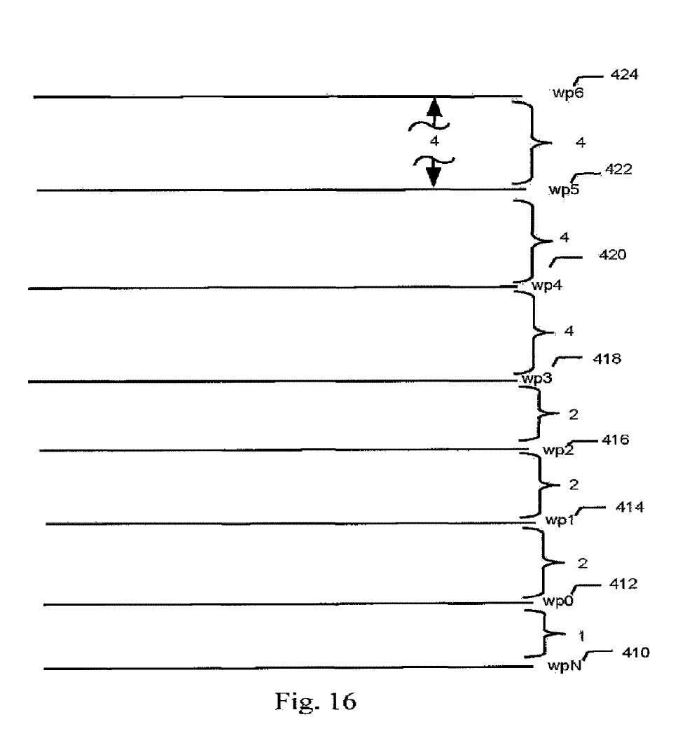

FIG. 16 depicts yet another embodiment of a write pointer scheme where three separate bit plane weightings are present. The least significant bit represents one bit plane weighting implemented once as 20, three bit planes have the identical weighting 21 and three bit planes have a second identical weighting 22. The sequence shown can develop gray scale levels from 0 to 15 with the same temporal efficiency as the original binary weighted sequences mentioned in the description of FIG. 11.

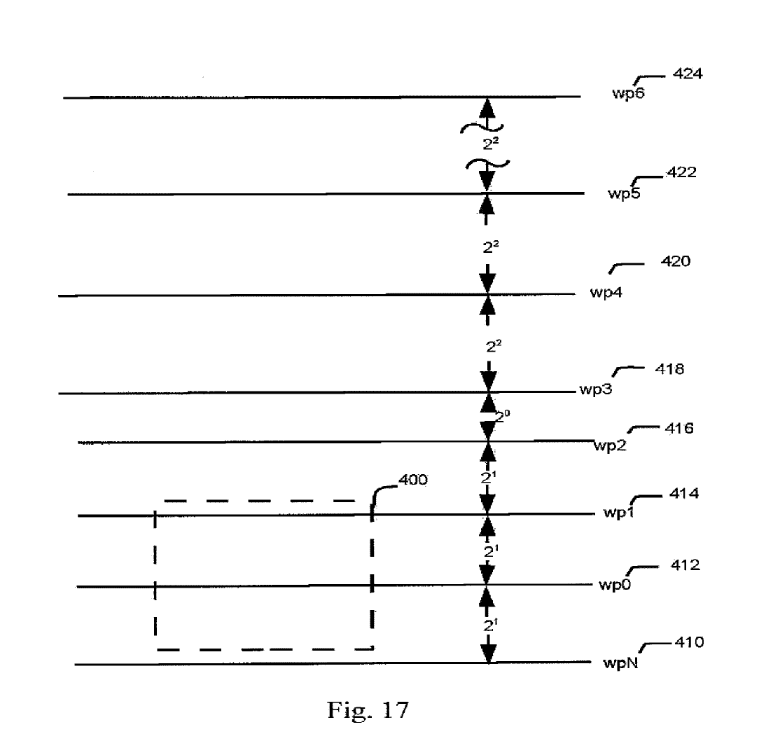

FIG. 17 depicts another embodiment of the gray level scheme disclosed for FIG. 16 above. In this sequence the LSB bit plane weighted at 2⁰ is placed between the three bit planes for 2¹ and the three bit planes for 2². A feature of this invention is that a bit plane parser may allocate higher order bits for 2² so that the slot adjacent to the LSB is populated first and the others in sequence afterward. Likewise the bit plane parser may allocated middle order bit for 2¹ such that the slot adjacent to the LSB is populated first and the other bits are then added in sequence. This creates a drive scheme where the data phasing errors are minimized and where the LSB is bounded by bit planes likely to be populated for a high number of gray levels with the result that the likelihood of erratic drive from the LSB as described above is minimized.

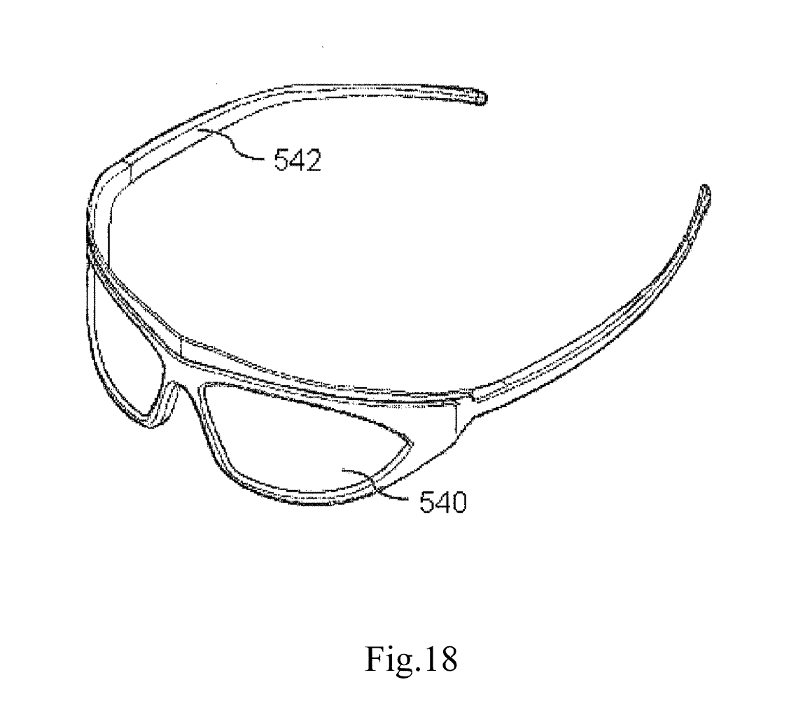

FIG. 18 shows that a display 540 according to the present invention may also be used in near-eye applications such as on a pair of glasses 542, googles, or other gear that may position the display 540 close to the head of the user. The display 540 may be within 3 inches of the user.

Although the invention has been described and illustrated in the above description and drawings, it is understood that this description is by example only and that numerous changes and modifications can be made by those skilled in the art without departing from the true spirit and scope of the invention. Each of the foregoing descriptions can be extended or merged with others without exceeding the scope of this invention. The use of row write spacing as a method of gray scale generation is the unique invention claimed. As a non-limiting example, a variety of different row spacings and weights may be used for gray scale generation. As another non-limiting example, additional physical write pointers be used to service the virtual write pointers on the display. The use of more than one physical write pointer is anticipated in the descriptions below as being equivalent to the use of a single physical write pointer in all respects except for the aforementioned bandwidth. As another non-limiting example, a device using 256 write pointers, all equal to one lsb, may be used to create gray scale (although the device would be enormously inefficient of bandwidth).

In some embodiments of the present invention, virtual write pointers progress across the screen at the same rate. In one mode of operation, each virtual write pointer is serviced by a physical write pointer in turn and then that virtual write pointer address is incremented or decremented to the row above or below it. The physical write pointer services the remaining virtual write pointers in sequence and then begins the writing again. In some instances there may be an intervening interval between the writing of the last virtual write pointer in sequence and the start of the next sequence of writings. Again, this is to insure that the velocity of the write pointers is constant and is a consequence of the fact that the number of virtual write pointers that are active on the display may vary as the associated bit weightings vary.

In the drawings associated herein, a presumption is made that the virtual write pointers move down the display, such as indicated by arrow 408 in FIG. 11. It should be understood, however, that in any of the above embodiments, the virtual write pointers could move up the display, or to the left or to the right, or in some combination of the above, or in some other direction.

The servicing of virtual write pointers is assumed to be linear in the present discussions. It would be possible to service the virtual write pointers in a manner other than linear without deviating from the intention of this invention. Indeed, it may be possible to vary the write order slightly to create minor variations of less than one LSB in the gray scale values of the pixels in a given row. This would be in support of techniques such as error diffusion and the like used to reduce the visibility of gray scale contouring.

In any of the embodiments above, it may be possible to incorporate more than one physical write pointer. As a non-limiting example, the display may be divided into segments such as a top third, middle third, and bottom third. One physical write pointer may be used for writing rows in each section. In another non-limiting example, the physical write pointers may be interleaved instead of being separated into different section. There may also be some combination of the two embodiments mentioned above where the write pointers may be interleaved in one section, but not interleaved in another section.

Although not an efficient embodiment, if there is only one write pointer, it may be possible to write the entire display from top to bottom (or other orientation) and then come back and overwrite it again. In order to have different gray levels we would be rewriting the same data over the top of the thing and not changing some bits and changing others. This would be the least efficient arrangement. In addition, it should be noted that embodiments of the present invention may include a mix of binary and non-binary weightings or even one that is completely not binary. The present invention may be particular useful with micro-LED displays.

Thus applicant has demonstrated embodiments capable of pulse width modulating a scrolling color projection system. Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

What is claimed is:

1. A method for modulating a micro-LED display, wherein said micro-LED display comprising a plurality of micro-LED pixels disposed in rows and columns array, said method comprising:
using row write actions to write data to said rows of micro-LED pixels; and
using spacing of row write actions to create grey scale modulation, wherein one spacing between sequential row write actions is at a first distance while another spacing between sequential row write actions is at a second distance greater than said first distance.

2. The method of claim 1, wherein said grey scale modulation is related to a pulse-width modulation (PWM) duty cycle.

3. The method of claim 1, wherein said micro-LED display comprises a silicon substrate including an integration circuit, each micro-LED pixel is disposed on the silicon substrate and emits image when being driven by two electrode currents from said integration circuit.

4. The method of claim 3, wherein said two electrode currents of each micro-LED pixel is toggled by using a pulse-width modulation (PWM).

5. The method of claim 2 or 4, wherein said integration circuit comprises a plurality of static random-access memory (SRAM) cells, each SRAM cell has two stable states, which are used to denote a zero state and an one state, and said PWM is toggled by said two stable states.

6. The method of claim 1 wherein said first distance is associated with a least significant bit (LSB).

7. The method of claim 6 wherein weighting of said LSB is modified to a longer value by adding an integer number of rows to said first distance between the row write actions generating said LSB.

8. The method of claim 1 wherein spacing between row write actions creates a weighted gray scale modulation in linear order.

9. The method of claim 1 wherein spacing between row write actions creates weighted gray scale modulation in other than linear order.

10. The method of claim 1 wherein spacing between row write actions sequentially is non-uniform.

11. The method of claim 1 wherein time between one row write action and a next writing of that same row determines a gray scale for that row.

12. The method of claim 1 wherein a plurality of physical write pointers are simultaneously used for said row write actions.

13. A method of modulating a micro-LED display, wherein said micro-LED display comprising a plurality of micro-LED pixels disposed in rows and columns array, said method comprising:
writing a first bit of said micro-LED pixels of a first row;
writing said first bits of said micro-LED pixels of a second row; and
writing said first bit of said micro-LED pixels of a third row,
wherein said first row and said second row is spaced at a first distance, said second row and said third row is spaced at a second distance which is a multiple of 2 of the first distance.

14. The method of claim 13, wherein said micro-LED display comprises a silicon substrate including an integration circuit, said micro-LED pixels are disposed on the silicon substrate and emit image when being driven by two electrode currents from said integration circuit.

15. The method of claim 14, wherein said two electrode currents of each micro-LED pixel is toggled by using a pulse-width modulation (PWM).

16. The method of claims 15, wherein said integration circuit comprises a plurality of static random-access memory (SRAM) cells, each SRAM cell has two stable states, which are used to denote a zero state and an one state, and said PWM is toggled by said two stable states.

17. The method of claim 13, further comprising:
writing a second bit of said micro-LED pixels of the first row; and
writing a third bit of said micro-LED pixels of the first row,
wherein a first time interval between the writing of the first bit and the writing of the second bit is a multiple of 2 of a second time interval between the writing of the second bit and the writing of the third bit.

18. The method of claim 13, further comprising:
writing a fourth bit of said micro-LED pixels of the first row on said display,
wherein a third time interval between the writing of the third bit and the writing of the fourth bit is not a binary multiple of the first time interval and is not a binary multiple of the second time interval.

19. The method of claim 13, further comprising:
writing the first bits of said micro-LED pixels of a fourth row on said display,
wherein the third row and the fourth row is spaced at a third distance which is not a binary multiple of the first distance and is not a binary multiple of the second distance.
